(19) United States
(12) Patent Application Publication
(10) Pub. No.: US 2016/0271553 A1
(43) Pub. Date: Sep. 22, 2016

(54) MULTI-STAGE HOOD FILTER

(71) Applicant: Jordan SALPIETRA, Shreveport, LA (US)

(72) Inventor: Jordan SALPIETRA, Shreveport, LA (US)

(21) Appl. No.: 15/072,063

(22) Filed: Mar. 16, 2016

Related U.S. Application Data
(63) Continuation-in-part of application No. 14/304,765, filed on Jun. 13, 2014.
(60) Provisional application No. 61/835,383, filed on Jun. 14, 2013.
(60) Provisional application No. 62/133,987, filed on Mar. 16, 2015.

(51) Int. Cl. B01D 50/00; B01D 45/08; F24C 15/20; B01D 39/18; B01D 39/16; B01D 46/10; B01D 46/00

(52) U.S. Cl. CPC B01D 50/002; B01D 46/10; B01D 45/08; B01D 46/0049; B01D 46/0093; B01D 39/18; B01D 39/1615; F24C 15/2035

(57) ABSTRACT

A filter assembly includes a housing and a diffuser permanently affixed within a central portion of the housing. A baffle assembly is permanently affixed within the housing adjacent the diffuser. A removable support structure is installed within the housing on a side of the diffuser opposite the baffle assembly. A removable filter pad is installed between the removable support structure and the diffuser. The removable support structure may be supported on opposite ends by opposing lips of the housing.

### CROSS-REFERENCE TO RELATED APPLICATIONS

This application is a continuation-in-part of U.S. non-provisional application Ser. No. 14/304,765, filed Jun. 13, 2014, which claims priority to U.S. provisional application Ser. No. 61/835,383, filed Jun. 14, 2013, and claims priority to U.S. provisional application Ser. No. 62/133,987, filed Mar. 16, 2015, the disclosures of all of the above being hereby incorporated by reference in their entireties.

### FIELD OF THE INVENTION

The present invention relates generally to filters for use in exhaust hoods and, more particularly, to multi-staged filters for use within such hoods.

### BACKGROUND

In a typical restaurant kitchen, a plurality of cooking units are lined up side by side in a row under common exhaust hoods. The cooking units may include, for example, ranges, griddles, fryers, and broilers. The cooking processes performed on such equipment all produce air laden with grease, smoke, fumes, moisture, heat, and other particles in varying amounts and temperatures. The air is drawn in to the exhaust hood, where it is filtered. One known filtration system is disclosed in U.S. Pat. No. 7,581,539 B2 to Aviles at al., the disclosure of which is hereby incorporated by reference.

### BRIEF SUMMARY

In accordance with a particular embodiment, a multi-staged grease filtration system is designed to completely fit inside of a standard two inch wide baffle filter channel in a ventilation hood. The system includes a first filter and a second filter, operatively disposed in series. The first filter includes a filter material with an upstream surface and a downstream surface, an external support element abutting either the upstream or downstream surface, and is configured to be mounted within the upstream side of the second filter. The external support may attach to the filter material without the use of any additional support on the opposite side of the filter material. The second filter is configured to be mounted within the ventilation hood, has a perforated air diffuser in a middle portion of a housing of the system, a flame barrier, and an upstream opening that holds the first filter.

The first filter may be disposed upstream or downstream of the second filter.

The first filter may comprise: a filter material comprising a first and second surface opposite the first surface; an exterior support structure abutting one of the first surface and the second surface of the filter material; one or more fastening elements disposed adjacent the periphery of the side of the exterior support structure that is abutting the one of the first surface and the second surface, the one or more fastening elements configured to hold the filter material substantially in place with respect to the exterior support structure, wherein the exterior support structure gives rigidity to the filter material.

### BRIEF DESCRIPTION OF THE DRAWINGS

For a more complete understanding of the embodiments of the present invention, needs satisfied thereby, and the objects, features, and advantages thereof, reference now is made to the following description taken in connection with the accompanying drawings.

FIG. 1 is a perspective view of filter assemblies mounted in an exhaust hood above a cooking apparatus, according to an embodiment of the invention.

FIG. 2 is a perspective view of a filter assemblies being lifted by a mounting tool into an opening in the exhaust hood, according to an embodiment of the invention.

FIG. 3 is perspective view of the components of the filter assembly with the external support structure removed and the filter material folded back inside of the opening within the second filter, according to an embodiment of the invention.

FIG. 4 is a front isometric view of the filter assembly, according to the embodiment of the invention.

FIG. 5 is a schematic cross-sectional view of the filter assembly, according to an embodiment of the invention.

FIG. 6 is a back isometric view of the filter assembly, according to an embodiment of the invention.

FIG. 7 is an enlarged front view of the first filter, according to an embodiment of the invention.

FIG. 8 is perspective view of the bottom of the filter assembly, according to an embodiment of the invention.

FIG. 9 is an exploded perspective view of the filter assembly, according to an embodiment of the invention.

FIG. 10 is an exploded perspective view of the filter assembly, according to an embodiment of the invention.

### DETAILED DESCRIPTION

Commercial exhaust hoods manufactured to be installed in the U.S. must comply with certain codes and standards, such as the National Fire Protection Associates (NFPA) Standard 96. This standard requires that all hoods used in commercial cooking establishments that are installed over cooking equipment that creates effluents other than heat and steam, such as grease, during the cooking process include grease removal devices that are individually listed in accordance with Underwrites Laboratories (UL) Standard 1046, or as components of UL 710 listed hoods. This standard requires grease removal devices to be able to prevent the spread of fire from the upstream face of the filter to an area downstream of the filter.

Since standard exhaust hoods have a two inch wide filter channel for the standard two inch thick baffle filters, other embodiments of disposable grease filters that are fiber based may require welding or drilling to modify the exhaust hood and/or existing baffle filters since there is no space within the filter channel to fit the additional disposable grease filter adjacent the baffle filters.

Example embodiments of this disclosure include a multi-staged grease filtration system designed to completely fit inside of a standard two inch wide baffle filter channel in a ventilation hood including a first filter with high efficiency grease filtration capabilities, and at least one second filter located downstream (with respect to the direction of air flow through the filter and hood) of the first filter. The first filter includes filter material attached to an external support structure that is made of relatively more rigid material. The second filter is preferably effective at preventing the spread of fire from the upstream face of the filtration system to an area downstream of the system.

The second filter may be any filter that drains grease out of the filter, and is preferably also an effective fire barrier. One example of a filter for a ventilation hood that drains grease to a grease drain and is an effective fire barrier is a baffle-type filter, such as that disclosed in U.S. Pat. No. 3,910,782 to Struble et al, the disclosure of which is hereby incorporated by reference.

It is understood that other grease-draining and fire barrier filters are within the spirit and scope of the embodiments of the present disclosure.

A baffle filter is very effective at preventing fire from traveling downstream as required by UL Standard 1046. However, while the baffle filter is satisfactory at filtering out grease with a particle size of greater than about 10 micrometers (≈m), but it is less effective with smaller particles. Therefore, embodiments of the present invention further include a first disposable or permanent filter, located upstream of the second filter in the airflow direction, the second filter being separate to the first filter. Moreover, baffle filters are difficult to clean and re-use so it is beneficial to have a disposable filter upstream from the baffle filter.

In particular embodiments, the filter material is made, in whole or in part, of fibers, such as natural, synthetic, and/or hybrid fibers, with or without a stabilizer frame, such as, for example and without limitation, the filter disclosed in U.S. Pat. No. 8,277,530 B2 to Alexander et al., the disclosure of which is hereby incorporated by reference. In other embodiments, the filter material is made, in whole or in part, of wool fiber, such as, for example and without limitation, the filter disclosed in U.S. Pat. No. 6,293,983 to More, the disclosure of which is hereby incorporated by reference.

A recent change in the UL 1046 standard now allows for testing of so-called “multi-stage” filters. Materials that cannot and could not pass the fire safety requirement of the standard individually may be utilized if the filter assembly as a whole can pass the tests mandated by the standard.

Embodiments of the present disclosure thus provide a filtration system with both a first filter and a second filter, in which the second filter is a very effective fire barrier, and the first filter is very effective at entrapping particulates. The resulting combination provides superior performance in both respects, while simplifying the installation procedure and reducing the renewable costs associated with disposable filter material.

In some embodiments, the first filter is made, in part, of metal mesh or fibers, such as natural, synthetic, and/or hybrid fibers, such as, for example and without limitation, wool fibers, wood-based viscose fibers, and cellulose-based synthetic fibers. The blend of fibers may include blending wool fibers with flame resistant viscose fibers; carding the blend into a fiber web; spraying the fiber web with a binder; needle punching the fiber web into a non-woven blanket; and applying a bonding emulsion to the wool fibers. Particular embodiments may further comprise applying a vacuum to the non-woven blanket and/or passing the non-woven blanket through an oven at over 280 degrees Fahrenheit. In some embodiments, the first filter is made of organic material, such as natural organic material. In some embodiments, the second filter is made of animal-derived organic material, such as wool.

Other filter materials are within the scope of the appended claims.

The material of the first filter may be disposed adjacent to or attached to an external support structure made of relatively more rigid material. While fiber filters are advantageous for their particle filtration abilities, their rigidity is similar to that of paper towels if an internal frame, or an external housing that sandwiches the filter material between two surfaces, is not present. Internal frame options result in expensive manufacturing costs, while a sandwiching external housing that sandwiches the filter material between two surfaces compresses the filter material resulting in less grease loading capabilities while increasing airflow resistance. For this reason, their use is limited despite their filtration properties.

By attaching a single surface of the fiber material to one surface of an external support structure, the drawbacks caused by the fiber material's lack of rigidity may be rectified. In a particular embodiment, the external support structure may contain fastening elements that grip the filter material to hold it in place. In this way, the material may gain rigidity for easier installation and removal, while mounting its original loft, density, grease loading abilities and minimal airflow resistance.

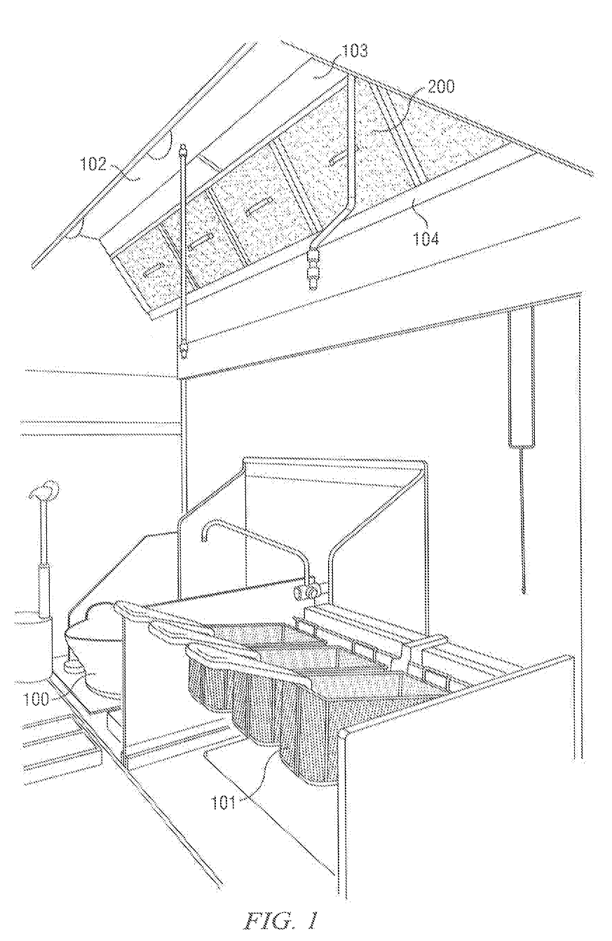

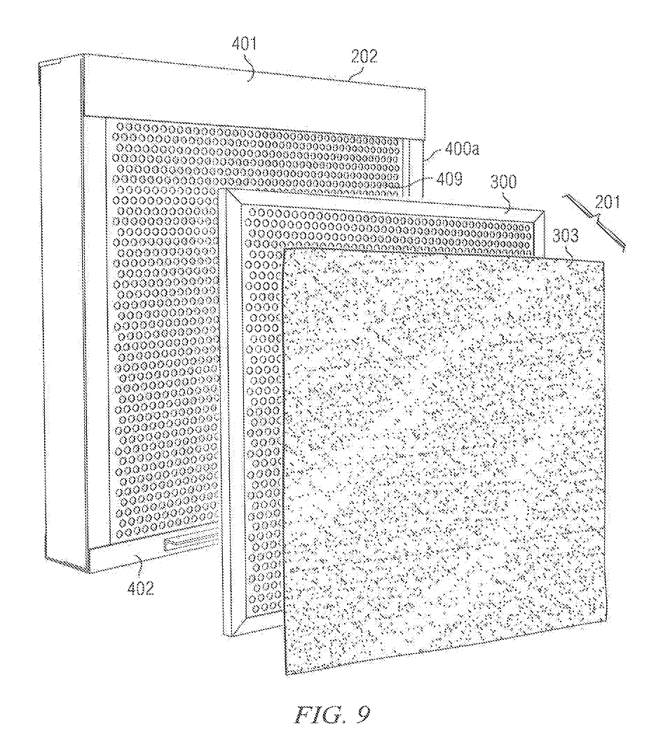

As set forth above, the first filter may be installed upstream of the second filters in an exhaust hood canopy according to a particular embodiment, as depicted in FIG. 1. There are at least two alternative configurations for positioning the first filter with respect to the external support structure. First, the first filter may be positioned with the filter material on the downstream side of the external support structure in an airflow direction, similar to those depicted in FIG. 8. Second, the first filter may be positioned with the filter material on the upstream side of the external support structure similar to those depicted in FIG. 9. The additional benefit when the external support structure is positioned on the upstream side of the filter material would be that the external support structure would provide better aesthetics over the appearance of a soiled filter material. Alternatively, when the external support structure is configured on the downstream side of the filter material, the external support structure would remain cleaner for longer periods of time which results in reduced labor and associated cleaning costs.

As depicted in FIG. 1, the filter assemblies 200 mounted within a hood 102 over cooking equipment 100. A fryer 101 is illustrated for exemplary purposes. Alternatively, the cooking equipment may include, for example, ranges, griddles, fryers, broilers, or the like.

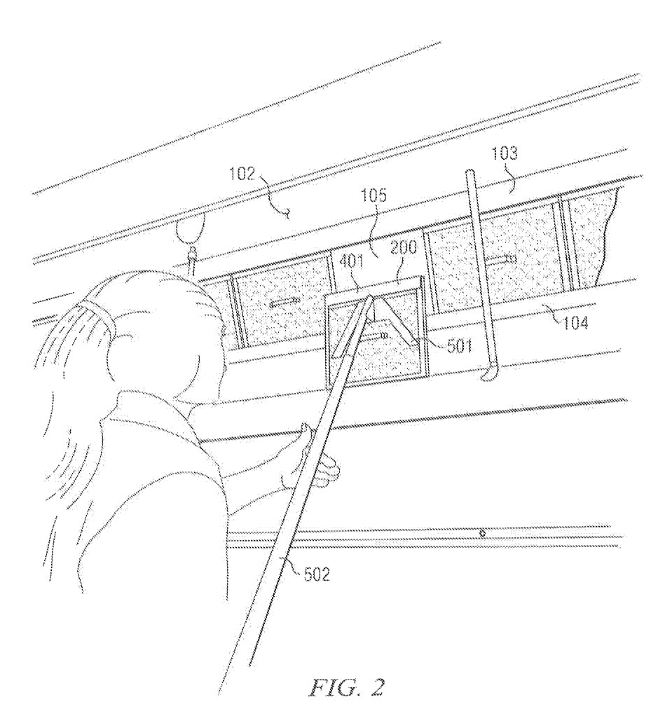

FIG. 2 depicts a filter assembly 200 being lifted by sliding the head 501 of a mounting tool 502 under the top lip 401 of the filter assembly 200, and maneuvering the filter assembly up into the an opening 105 and top channel 103 within the hood 200 where it will rest down into the bottom channel 104.

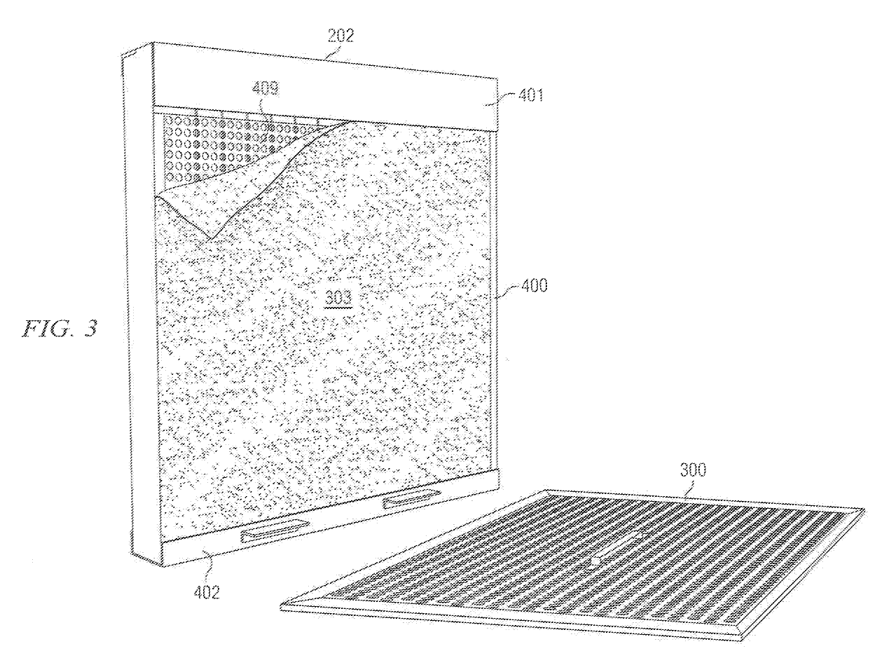

FIG. 3 shows the exterior support structure 300 removed from the housing 400, while the filter material 303 has been inserted behind the top lip 401 and bottom lip 402 of the second filter 202. The filter material 303 has been folded back to reveal the downstream perforated air diffuser 409.

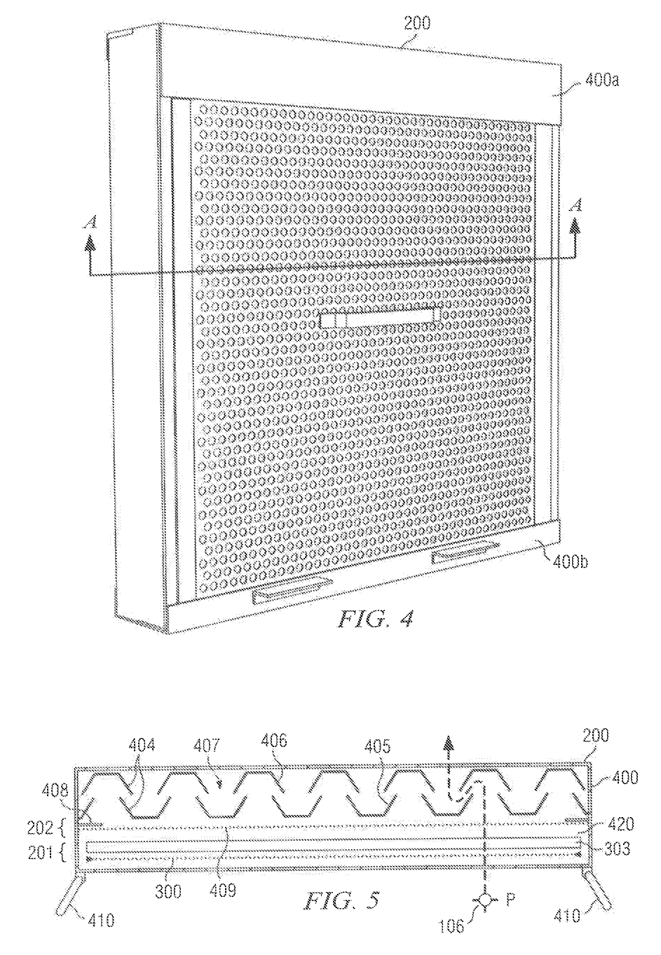

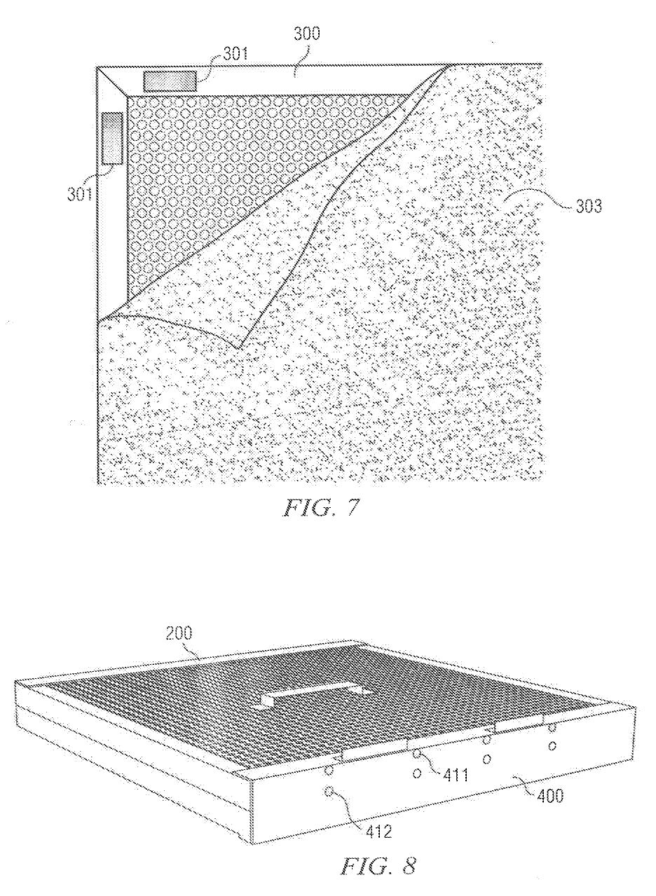

FIG. 4 shows a front isometric view of the filter assembly 200 and a reference line used to indicate a cross-sectional view as depicted in FIG. 7.

FIG. 5 illustrates one of the cross-section views of the filter assembly 200 that was referenced in FIG. 4, wherein the filter assembly 200 may include the following components: a first filter 201 and a second filter 202. The first filter 201 may include an exterior support structure 300 and filter material 303. The second filter 202 may include middle divider tabs 408 (optional), a perforated air diffuser 409, and a baffle assembly 404 all enclosed within the housing 400. The baffle assembly 404 by comprise of an upstream row of vertical baffle ribs 405 and a downstream row of vertical baffle ribs 406, each being offset from the other to define an airflow spacing 407. Optional vertical bail handles 410 may be added to the housing 400. The filter assembly 200 may define tortuous paths “P” 106 that may enter the filter assembly 200 via the first filter 201, then through the perforated air diffuser 409, then through the airflow spacing 407 provided by the baffle assembly 404.

The majority of the grease may be filtered from the airflow by the filter material 303 within the first filter 201. Any remaining grease carried in passing air may adhere to upstream row of vertical baffle ribs 405 and a downstream row of vertical baffle ribs 406. Thereafter, baffles assembly 404 may function as a channel, or gutter, and direct the accumulation of grease under the force of gravity to the bottom of the filter assembly 200 as further described in FIG. 8

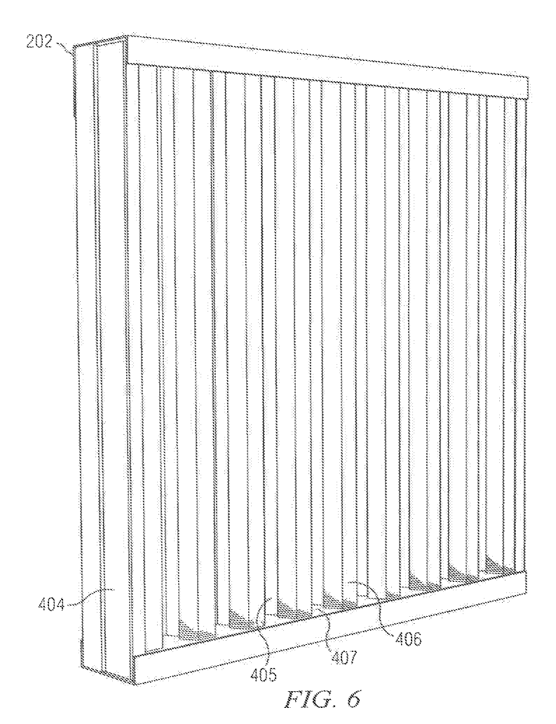

FIG. 6 shows the back side of the second filter 202 revealing a baffle filter assembly 404 comprising of a upstream row of vertical ribs 405, a downstream row of vertical ribs 406 and airflow openings 407.

The embodiments of FIGS. 4-6 may be configured such that the baffle assembly 404 and the perforated air diffuser 409 are fixed within housing 400, and the exterior support structure 300 and filter material 303 are removable from housing 400. This allows the filter material to be replaced periodically, without having to remove the entire housing from the kitchen hood. The filter material 303 may simply be placed against the exterior support structure 300 and then the exterior support structure inserted within the housing 400. Upper lip 400a and lower lip 400b of housing 400 hold exterior support structure 300 in place within housing 400.

When installed in this manner within hood 102, gravity will pull exterior support structure 300 away from diffuser 409 such that the filter material will not be compressed between diffuser 409 and exterior support structure 300. This allows for an air gap 420 between filter material 303 and diffuser 409. This air gap and the lack of compression of filter material 303 allows filter material 303 to operate more efficiently at removing grease particulates from the air. Removable exterior support structure may also be perforated to allow for sufficient air flow there through.

In the illustrated embodiment, upper lip 400a is approximately 2″ but may be between 1″ and 3″ in order to secure the exterior support structure in place. Similarly, lower lip 400b is approximately 1″ but could be between 0.05″ and 1.5″ in order to secure the exterior support structure in place. Since the overall height of the housing is approximately 15.5″ and the overall height of the exterior support structure is approximately 14.5″, the exterior support structure easily fits within the housing and lips 400a and 400b hold it in place.

In the illustrated embodiment, the thickness of the exterior support is approximately 0.25″ but could be within a range of 0.15″ to 0.5″. The filter material (e.g., filter pad) is approximately 0.125″ thick but could be within a range of 0.1″ to 0.4″ within the teachings of the disclosure.

FIG. 7 shows an embodiment of this invention where the filter material 303 is attached the exterior support structure 300 with the use of independent fastening elements 301 which can be located on any one or more sides of the external support structure 300, and are designed like velcro or hooks to adhere or penetrate directly to the filter materials 303 woven or nonwoven surface. The fastening elements 301 can be any size or shape, and attached to external support structures 300 using either adhesive, welding, riveting, sewing, screwing or any combination thereof.

Other independent fastening elements 301 are within the scope of the appended claims. For example, in particular embodiments, the filter material may be attached to the external support structure using clasps, hook and loop fasteners, clamps, adhesive, stick tacks, hooks or other similar means.

FIG. 8 shows the bottom of the housing 400 of the filter assembly 200 which may comprise of a series of drainage apertures 411 and 412, for the first filter and second filter respectively, through which the grease may travel on its way to a ventilation hoods holding reservoir (not shown).

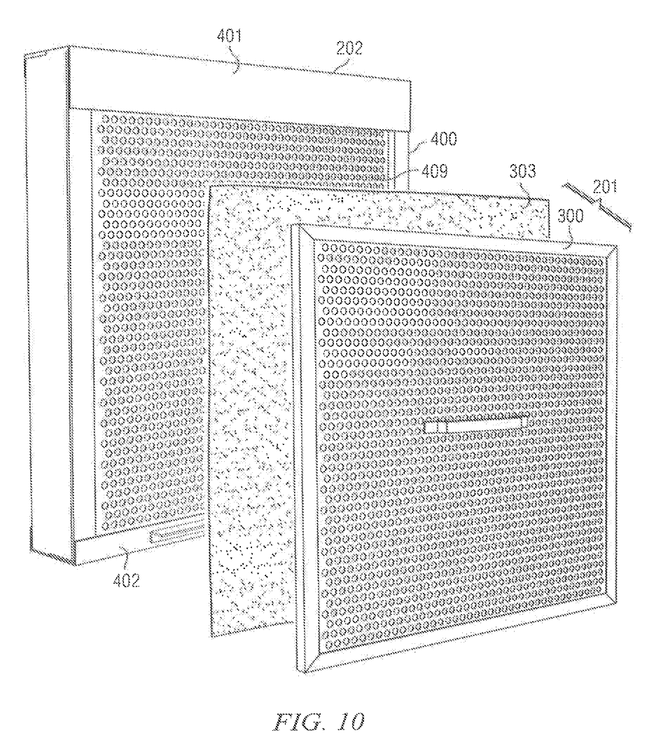

FIGS. 9-10 show two configuration options in which the first filter 201 is placed in the upstream of a second filter 202.

FIG. 9 shows that within the first filter 201, the external support structure 201 is oriented downstream of the filter material 303. This may be done so that the filter material 303 filters the air before it come into contact with the external support structure 300, reducing the need for the external support structure 300 to be cleaned nightly and still giving rigidity to the filter material 303.

FIG. 10 shows that within the first filter 201, the external support structure 201 is oriented upstream of the filter material 303. This may be done so that the external support structure 300 offers better aesthetics while maintaining rigidity to the filter material 303. This configuration is further illustrated in the embodiment of FIGS. 1-5.

In accordance with a particular embodiment of the present invention, components of the filter assembly may be made from stainless steel. For example, re-usable components of the system including the baffle assembly, air diffuser, housing and exterior support structure may be made of stainless steel. The filter material that comprises the disposable filter may be made from a variety of different materials, including a combination of wool and viscose materials. In certain embodiments, it is advantageous to have wool comprise more than 50% and in some cases more than 75% of the blend of materials of the filter material. For example, wool may account for 60% to 90%, or 70% to 80% of the blend. In such embodiments, viscose may be the only other material in the blend and account for the balance of the material. In other embodiments, it is more advantageous to include more than 50% and in some case more than 75% of viscose material in the blend. Similarly, viscose may comprise 60% to 90%, or 70% to 80% of the blend. In such embodiments, wool may be the only other material in the blend and account for the balance of the material.

It is advantageous to size the filter assembly to allow it to be inserted into a hood to replace a two inch baffle filter. Accordingly, the thickness of the housing and in some embodiments the entire filter assembly may be within the range of one and one-half to two inches thick. In certain embodiments, in order to allow the best “fit” within the hood, the total thickness would be within a range of 1.65″ to 1.95″. In certain illustrated embodiment herein, a 1.75″ thick assembly is illustrated.

In particular embodiments, the filter assembly of FIGS. 4-6 may be a square configuration with sides of a length within a range of 14″ to 16″. This would allow the multi-stage filter to replace a standard baffle filter in a standard hood. In the illustrated embodiment, the sides of the filter are approximately 15.5″ long.

In order to fit within the housing of the filter assembly, the exterior support structure is configured to be a square or rectangular configuration that is slightly smaller than the filter assembly. In the illustrated embodiment, the exterior support structure is approximately 14.5″ by 15″. The “short” side corresponds to the side that will engage the top and bottom lips of the housing. In other embodiments, the sides of the exterior support structure may be from 13.5″ to 15.5″ with the “short” side being approximately ½ inch shorter than the long side.

FIGS. 4-6 are generally illustrated to scale. Thus, the baffle filter takes up greater than 50% of the thickness of the filter assembly. In various embodiments, the baffle filter may comprise 55% to 75% of such thickness. The exterior support structure and filter material together comprise less than ⅓ of the thickness. In various embodiments, the exterior support structure may comprise 15% to 40% of the thickness. In particular embodiments, the filter material (e.g., filter pad) may be slightly longer than the exterior support structure in at least one dimension to allow for the filter assembly to lap over the exterior support structure on at least two sides of the exterior support structure, and in some embodiments on all four sides.

In accordance with a particular embodiment, the rigidity provided by the exterior support structure may be advantageous for more easily handling the filter material during the installation and removal of the filter material, thereby shortening the time and effort required for installation and removal.

The first filter may be orientated with the external support element either on the upstream or downstream side of the filter material for aesthetics and maintenance purposes benefits.

The external support structure may not require any additional support on the opposite side of the filter material.

The first filter may be attached, such as removably attached, to the second filter.

The filter material of the first filter may be natural fibers, hybrid fibers, synthetic fibers or any combination thereof.

The second filters elements may cooperate to define an opening for the first filter.

The second filter may comprise: a housing, top lip, bottom lip, hanging clips, flame barrier, drain holes, middle divider tabs and a perforated air diffuser.

The flame barrier within the second filter may be one or more baffle filters, metal mesh filters or any other known flame barrier.

The ventilation hood may include a track, and the second filter may be configured to be inserted and possibly clipped onto the hood with the use of the filter assembly's hanging clips and be moved along the track. The first filter may also be configured to be inserted the second filter and into the hood by being moved along the track.

What is claimed is:

1. A filter assembly, comprising:
a housing;
a diffuser permanently affixed within a central portion of the housing;
a baffle assembly permanently affixed within the housing adjacent the diffuser;
a removable support structure installed within the housing on a side of the diffuser opposite the baffle assembly;
a removable filter pad installed between the removable support structure and the diffuser; and
wherein the removable support structure is supported on opposite ends by opposing lips of the housing.

2. The filter assembly of claim 1, wherein the removable support structure and removable filter pad are sized to allow for an air gap of greater than approximately ¼″ between the removable filter pad and the diffuser.

3. The filter assembly of claim 1, wherein the removable filter pad comprises wool fibers and viscose fibers.

4. The filter assembly of claim 3, wherein the viscose fibers comprise 50-95% of the removable filter pad.

5. The filter assembly of claim 3, wherein the wool fibers comprise 50-95% of the removable filter pad.

6. The filter assembly of claim 1, wherein the filter pad, the removable support structure and the diffuser are laterally spaced from the baffle assembly to allow a path of air through the baffle assembly.

7. The filter assembly of claim 1, wherein the removable support structure includes a back support portion with perforations formed therein.
